(19) United States
(12) Patent Application Publication
(10) Pub. No.: US 2021/0032148 A1
(43) Pub. Date: Feb. 4, 2021

(54) APPARATUS AND METHOD FOR PRODUCING GLASS

(71) Applicant: CORNING INCORPORATED, CORNING, NY (US)

(72) Inventors: JASON ARTHUR HOWLES, CORNING, NY (US); WILLIAM BRASHEAR MATTINGLY, Painted Post, NY (US); RICHARD ALAN SHELLEMAN, HORSEHEADS, NY (US)

(21) Appl. No.: 16/768,238

(22) PCT Filed: Nov. 30, 2018
(86) PCT No.: PCT/US2018/063408

§ 371 Date: May 29, 2020

Related U.S. Application Data
(60) Provisional application No. 62/593,352, filed on Dec. 1, 2017.

(51) Int. Cl. C03B 5/225; C03B 5/43; C03B 7/02

(52) U.S. Cl. CPC C03B 5/225; C03B 7/02; C03B 5/43

(57) ABSTRACT

A fining apparatus for producing glass articles, methods of manufacturing a fining apparatus and methods of manufacturing glass articles in a fining apparatus are disclosed. The expansion characteristics of a fining vessel (205) comprising platinum and a cradle (201) comprising zirconia are selected to prevent rupture of the fining vessel upon cooling of the fining apparatus.

### CROSS-REFERENCE TO RELATED APPLICATION

This application claims the benefit of priority under 35 U.S.C. § 119 of U.S. Provisional Application Ser. No. 62/593,352 filed on Dec. 1, 2017, the content of which is relied upon and incorporated herein by reference in its entirety.

### FIELD

Embodiments of the disclosure generally relate to apparatus and methods for the manufacture of glass, glass articles and refractory materials used in these apparatus and methods, the apparatus and methods comprising refractory materials and a metal fining vessel.

### BACKGROUND

Glass manufacturing apparatus, systems and methods are utilized in a wide variety of fields, and molten glass is produced and moved through such apparatus systems and formed into various glass articles, for example, glass sheets, glass containers and other glass parts.

In the manufacture of glass sheets, display quality glass sheets have been commercially produced using the float process, rolling process, updraw process, slot draw process, and downdraw process, including the fusion overflow downdraw process (fusion process). In each case, the process involves three basic steps: melting batch materials in a tank (also called glass melters or melters), conditioning the molten glass to remove gaseous inclusions and to homogenize the molten glass in a fining vessel comprising platinum in preparation for forming, and forming, which in the case of the float process involves the use of a molten tin bath, while for the fusion process, involves the use of a forming structure, e.g., an isopipe. In each case, the forming step produces a ribbon of glass which is separated into individual glass sheets. The various components of the tank, the fining vessel and the forming structure are made from refractory materials to provide structures called refractories. With respect to the fining vessel, because platinum is a precious metal and quite expensive, the walls of the fining vessel are generally manufactured as thinly as possible. Thus, the fining vessel may benefit from physical support in the form of a cradle.

In glass manufacturing facilities operating at full production capacity, it is generally desirable to maximize equipment utilization and to avoid equipment downtime due to equipment failure. It would be desirable to provide materials for use in apparatus and methods for producing glass that result in improved manufacturing processes and higher equipment utilization and less equipment downtime, for example in a fining apparatus of a glass manufacturing system.

### SUMMARY

A first aspect of the disclosure pertains to a fining apparatus for producing a glass article. The fining apparatus comprises a fining vessel comprising platinum having a length L_{V} and a fused cast or sintered zirconia cradle having a length L_{C}, the fining vessel having a first coefficient of thermal expansion such that the fining vessel exhibits a fractional change in length

$$\frac{{L}_{VT 1} - {L}_{VT 2}}{{L}_{VT 1}}$$

upon cooling from a first temperature (T₁) to a second temperature (T₂). The cradle encloses at least a portion of the fining vessel along the length of the fining vessel, the cradle comprising a material having a second coefficient of thermal expansion such that the cradle exhibits a fractional change in length

$$\frac{{L}_{CT 1} - {L}_{CT 2}}{{L}_{CT 1}}$$

upon cooling from the first temperature (T₁) to the second temperature (T₂), wherein the first temperature (T₁) is greater than or equal to 1050° C. and the second temperature (T₂) is less than or equal to 800° C. and

$$\vert \frac{{L}_{VT 1} - {L}_{VT 2}}{{L}_{VT 1}} - \frac{{L}_{CT 1} - {L}_{CT 2}}{{L}_{CT 1}} \vert$$

is greater than 0 and less than about 0.0090. In some embodiments, the material comprises 80-99.99% by weight zirconia.

Other aspects of the disclosure pertain to methods of manufacturing a fining apparatus and a method of manufacturing a glass article utilizing a fining apparatus as described herein.

### BRIEF DESCRIPTION OF THE DRAWINGS

The accompanying figures, which are incorporated in and constitute a part of this specification, illustrate several embodiments described below.

FIG. 1 is a schematic drawing illustrating an exemplary apparatus for producing a glass article, in particular, for making flat glass sheets;

FIG. 2A is a perspective view of a fining apparatus comprising a fining vessel and a cradle according to one or more embodiments;

FIG. 2B is a schematic illustration of the cross-section of a fining apparatus according to one or more embodiments;

FIG. 3 is a graph showing the thermal expansion behavior of a refractory metal comprising 80% platinum and 20% rhodium by weight compared with a commercially available unstabilized fused cast refractory; and

FIG. 4 is a graph showing the thermal expansion behavior of a refractory metal comprising 80% platinum and 20% rhodium by weight compared with various sintered (bonded) refractories in accordance with one or more embodiments.

### DETAILED DESCRIPTION

Before describing several exemplary embodiments, it is to be understood that the disclosure is not limited to the details of construction or process steps set forth in the following disclosure. The disclosure provided herein is capable of other embodiments and of being practiced or being carried out in various ways.

It was determined that in a fining apparatus for producing a glass article comprising a fining vessel of a first material at least partially surrounded by a cradle of a second material, a linear thermal expansion mismatch between the first and second materials causes failure of the fining vessel when the fining apparatus is cooled from high temperatures to room temperature. In particular, fining vessels typically comprise a platinum-containing metal, and the cradle comprises zirconium dioxide (“zirconia”), for example fused-cast zirconia or sintered zirconia. In use, a fining apparatus operates at temperatures as high as 1740° C., and when the fining apparatus is cooled from such high operating temperatures, the zirconia goes through an expansive phase transition in a temperature range of about 1000° C. to about 1250° C. during cooling through this temperature range. During such cooling, the cradle expands while the finer contracts, causing the contracting finer metal to tear or rupture and fail.

Therefore, with existing fining apparatus, a power failure or other event that causes the fining apparatus to be cooled below a temperature range of about 1000° C. to about 1250° C. will cause the fining apparatus to fail due to rupturing or tearing of the fining vessel. This failure of the fining apparatus causes significant down time and lost equipment utilization.

When cooled through a temperature in a range of from 800° C. to 1200° C. zirconia can undergo a change in crystal structure from a monoclinic to a tetragonal structure. Such crystal structure changes can be associated with significant volume changes (e.g., as high as about 4-5%), which can make it difficult to manage the manufacturing process, particularly for large-scale applications, and/or can add stress to the refractory parts during use at elevated operated temperatures. When sintered or bonded high zirconia refractories or fused cast high zirconia refractories are used as cradles to at least partially enclose platinum-containing refractory metal fining vessel, which may be in the form of a tube, the volume change in the cradle can rupture or tear the fining vessel.

For example, during heating, zirconia expands until a temperature of about 1170° C. when the zirconia transforms from monoclinic to the tetragonal phase and shrinks. After complete transformation to the tetragonal phase, zirconia continues to expand about 0.41%, but never returns back to the maximum expansion point of about 0.76% of the monoclinic phase. The platinum-containing tube expands throughout the heating cycle. During cooling, the metal fining vessel shrinks continuously, however the zirconia cradle undergoes expansion due to the tetragonal phase to monoclinic phase transformation, at about 950° C., for example. This expansion increases the size of the cradle about 0.55% such that the cradle is now larger than what it was at the operating temperature of about 1650° C. to about 1740° C. by about 0.41%. The cradle is now larger than it was at the operating temperature while the fining vessel comprising platinum has shrunk well below its size at the operating temperature, resulting in tears in the fining vessel and eventual failure of the fining apparatus or fining vessel.

A detailed investigation and study of the fining vessel and cradle materials and properties was conducted. Existing fused cast zirconia cradles comprise 93-94% monoclinic zirconia and a 6-7% glassy phase. The 6-7% glassy phase buffers the material from stresses due to the expansive phase transition on cool down, but the glassy phase does not prevent the cradle from expanding during cooling from the operating temperature of the fining apparatus. Thus, on cool down from a power outage or other occurrence, the cradle becomes larger than the shrinking fining vessel, resulting in cracking and failure of the fining vessel.

According to one or more embodiments of the disclosure, fused cast zirconia material or sintered zirconia (also called bonded zirconia) materials are partially or fully stabilized with an additive (e.g., yttrium) to provide a cradle with reduced expansion on cool down due to tetragonal to monoclinic phase transformation compared with unstabilized zirconia cradles. According to one or more embodiments, “fully stabilized” means that the material is in the tetragonal or cubic phases or a combination of both and does not form the monoclinic phase on cool down. In other words, according to one or more embodiments, “fully stabilized” means that the material comprises (on cool down) 100% tetragonal (t) and/or cubic (c) phases with zero monoclinic (m) phase. According to one or more embodiments, “partially stabilized” means that the material comprises (on cool down) a combination of the monoclinic (m), the tetragonal (t) and/or the cubic (c) phases. In some embodiments, “partially stabilized” means that the material comprises (on cool down) 10%-99% tetragonal (t) and/or cubic (c) phases with the remainder monoclinic (m) phase, or 20%-99% tetragonal (t) and/or cubic (c) phases with the remainder monoclinic (m) phase, or 30%-99% tetragonal (t) and/or cubic (c) phases with the remainder monoclinic (m) phase, or 40%-99% tetragonal (t) and/or cubic (c) phases with the remainder monoclinic (m) phase, or 50%-99% tetragonal (t) and/or cubic (c) phases with the remainder monoclinic (m) phase, or 60%-99% tetragonal (t) and/or cubic (c) phases with the remainder monoclinic (m) phase, or 70%-99% tetragonal (t) and/or cubic (c) phases with the remainder monoclinic (m) phase, or 80%-99% tetragonal (t) and/or cubic (c) phases with the remainder monoclinic (m) phase, or 85%-99% tetragonal (t) and/or cubic (c) phases with the remainder monoclinic (m) phase, or 90%-99% tetragonal (t) and/or cubic (c) phases with the remainder monoclinic (m) phase, or 95%-99% tetragonal (t) and/or cubic (c) phases with the remainder monoclinic (m) phase, or 96%-99% tetragonal (t) and/or cubic (c) phases with the remainder monoclinic (m) phase, or 97%-99% tetragonal (t) and/or cubic (c) phases with the remainder monoclinic (m) phase, or 98%-99% tetragonal (t) and/or cubic (c) phases with the remainder monoclinic (m) phase, or 99%-99.99% tetragonal (t) and/or cubic (c) phases with the remainder monoclinic (m) phase. The phase percentages according to one or more embodiments are determined by Rietveld Quantitative Analysis using x-ray diffraction, and the percentages are mass percent. In one or more embodiments, the degree of stabilization is such that the expansion on cool down is low enough so that the cradle does not grow to a size that would cause the fining vessel to rupture or tear, causing failure during cool down from power outages or other disruptions in power. This allows more time to recover power to the system before damage would occur.

Stabilized zirconias undergo destabilization over time at elevated temperature. In one or more embodiments, the smaller the stabilizing ion, the more mobile it is, and therefore, the rate and degree of destabilization is reduced as the stabilizing additive used is changed from magnesium to calcium to yttrium. According to some embodiments, the desired life of a fining apparatus is at least about six years, and therefore, yttrium stabilized zirconia can potentially meet this goal, and this goal can possibly be met with magnesia or calcium-stabilized zirconia.

In one or more embodiments, the cradle material has a closed pore microstructure to contain glass leaks. In one or more embodiments, the cradle material has acceptable high temperature mechanical strength and creep resistance to support the weight of the Pt and glass. Thus, according to embodiments of this disclosure, the use of a partially or fully stabilized fused cast or a partially or fully stabilized sintered zirconia (bonded zirconia) material or other suitably matched thermal expansion material which meets one or more of the goals stated above can minimize the expansion mismatch on cool down between the fining vessel comprising platinum. Such a cradle would protect the fining vessel comprising platinum from failure due to unplanned power outages or other events in which the fining apparatus is cooled from operating temperatures. This can extend the time for power recovery before damage is done to the system which brings the asset done prematurely. In some embodiments, a fining apparatus is provided which can be cooled and reheated also provides more options for repairs or modifications.

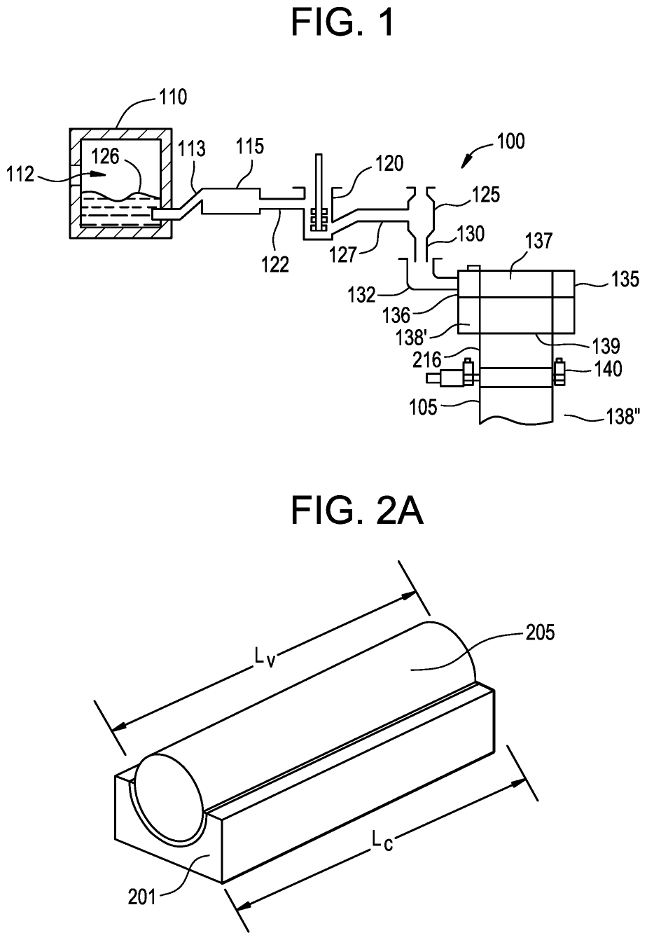

Referring to FIG. 1, there is a diagram of an exemplary glass manufacturing system or apparatus 100 that can use a glass manufacturing process. In FIG. 1, the fusion process is shown to make a glass substrate 105, which is typically in the form of a glass sheet. As shown in FIG. 1, the glass manufacturing system or apparatus 100 includes a melting vessel 110, a fining vessel 115, a mixing vessel 120 (e.g., stir chamber 120), a delivery vessel 125 (e.g., bowl 125), a forming apparatus 135 (e.g., isopipe 135) and a pull roll assembly 140 (e.g., draw machine 140). The melting vessel 110 is where the glass batch materials are introduced as shown by arrow 112 and melted to form molten glass 126. The temperature of the melting vessel (Tₘ) will vary based on the specific glass composition, but may be in a range of about 1400°-1750° C. For display glasses used in liquid crystal displays (LCDs), melting temperatures may exceed 1500° C., 1550° C., and for some glasses, may even exceed 1650° C. and reach 1740° C. A cooling refractory tube 113 may optionally be present connecting the melting vessel with the fining vessel 115. This cooling refractory tube 113 may have a temperature (T_{c}) that is in a range of about 0°-15° C. cooler than the temperature of the melting vessel 110. The fining vessel 115 (e.g., finer tube 115) has a high temperature processing area that receives the molten glass 126 (not shown) from the melting vessel 110 and in which bubbles are removed from the molten glass 126. The temperature of the fining vessel (T_{f}) is generally equal to or higher than that of the melting vessel (Tₘ) in order to lower viscosity and encourage gas removal from the molten glass. In some embodiments, the fining vessel temperature is in a range of from about 1600° to about 1740° C., and in some embodiments exceeds the temperature of the melting vessel by 20° to 70° C., or more. The fining vessel 115 is connected to the mixing vessel 120 (e.g., stir chamber 120) by a finer tube to stir chamber connecting tube 122. Within this connecting tube 122, the glass temperature is continually and steadily decreased from the fining vessel temperature (T_{f}) to the stir chamber temperature (Ts), which typically represents a temperature decrease of between 150° and 300° C. The mixing vessel 120 is connected to the delivery vessel 125 by a stir chamber to bowl connecting tube 127. The mixing vessel 120 is responsible for homogenizing the glass melt and removing concentration differences within the glass that can cause cord defects. The delivery vessel 125 delivers the molten glass 126 through a downcomer 130 to an inlet 132 and into the forming apparatus 135 (e.g., isopipe 135). The forming apparatus 135 includes a forming apparatus inlet 136 that receives the molten glass which flows into a trough 137 and then overflows and runs down two sides 138′ and 138″ before fusing together at root 139. The root 139 is where the two sides 138′ and 138″ come together and where the two overflow walls of molten glass 216 rejoin (e.g., refuse) before being drawn downward between two rolls in the pull roll assembly 140 to form the glass substrate 105.

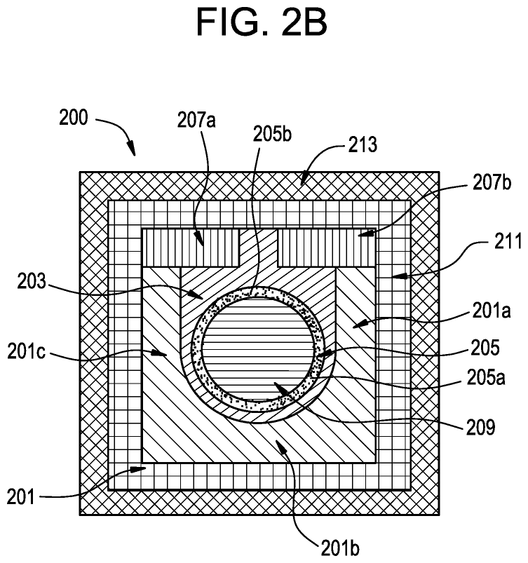

FIGS. 2A and 2B shown an embodiment of a fining system or fining apparatus (also referred to as a “finer”) according to one embodiment of the present disclosure, showing a metal fining vessel 205 (which may be in the form of a tube, and thus called a fining tube) in which molten glass 209 is contained and fined. There is shown a first side wall 201a, a base 201b, and a second side wall 201c of a deep cradle 201 containing a fining vessel 205 including a sidewall 205a and a top wall 205b. A bedding material 203 is between the cradle walls and the vessel. Cover plates 207a and 207b cover the vessel 205 and the bedding material. Thermal insulating layers 211 and 213 enclose the cradle 201 and the vessel 205. The thermal insulating layers 211 and 213 may be made of fire boards (such as high temperature-resistant fiber boards made of ceramic fiber). In the embodiment shown, the use of a deep cradle 201, in addition to the full insulation of the fining vessel, results in minimal heat loss in the fining process and maintains the temperature gradient of the fining vessel within a desired range. However, it will be understood that the disclosure is not limited to the embodiment shown in FIG. 2A. FIG. 2B is a perspective view of a fining apparatus comprising a fining vessel 205 and a cradle 201, showing the length of the fining vessel L_{V} and the length of the cradle L_{C}. In alternative embodiments, the fining apparatus can be a vacuum fining apparatus, for example, the type shown and described in U.S. Pat. No. 8,484,995.

In some embodiments, the cradle comprises fused cast zirconia or sintered zirconia which exhibits a high strength, low creep and high corrosion-resistance against molten oxide glass materials. The cradle supports a large portion of the weight of the system, including the cradle itself any castable included in the cradle, the metal fining vessel and any material such as molten glass contained therein. In certain embodiments, it is desired that the cradle has a unitary body structure, where the side walls and the base join together to form a seamless unitary piece. The base, the side walls, and the unitary piece, may be produced by fusing or sintering zirconia articles, along with additives at various amounts, into a near-net-shape cradle, or a fused cast zirconia or sintered zirconia block followed by machining.

The cradle may take various shapes, such as partial egg shell, a cubic block with an open cavity, and the like. In certain embodiments, the cradle takes the shape of a trough. The fining vessel containing high temperature fluid is at least partially enclosed in the cradle. The cradle may be further supported or fixed by additional structures, such as a shelf, a pedestal, railings, and the like.

In certain embodiments, the fused cast zirconia or sintered material for the cradle has a low level of open pore porosity. Open pores are vulnerable to molten glass penetration. In certain embodiments, the fused cast zirconia or sintered zirconia material comprises less than 10% by volume of open pores, in certain embodiments less than 8%, in certain embodiments less than 5%, in certain embodiments less than 3%.

In certain embodiments, the fused cast zirconia or sintered zirconia material for the cradle has a density of at least 4.8 g·cm⁻³, in certain embodiments at least 5.0 g·cm⁻³, in certain embodiments at least 5.2 g·cm⁻³, in certain embodiments at least 5.3 g·cm⁻³. Typically, the higher the density of the fused cast zirconia or sintered zirconia material, the lower the percentages of the pores contained therein. Zirconia has a theoretical maximal density of 5.89 g·cm⁻³ under standard conditions.

According to one or more embodiments, a fining apparatus 200 for producing a glass article is provided. The fining apparatus 200 comprises a fining vessel comprising platinum 205 comprising having a length L_{V} and a fused cast or sintered zirconia cradle having a length L_{C}, the fining vessel having a first coefficient of thermal expansion such that the fining vessel 205 exhibits a fractional change in length

$$\frac{{L}_{VT 1} - {L}_{VT 2}}{{L}_{VT 1}}$$

upon cooling from a first temperature (T₁) to a second temperature (T₂). The fining apparatus 200 further comprises a cradle enclosing at least a portion of the fining vessel along the length of the fining vessel, the cradle comprising a material comprising at least 80% zirconia, that is fused cast or sintered and the cradle having a second coefficient of thermal expansion such that the cradle exhibits a fractional change in length

$$\frac{{L}_{CT 1} - {L}_{CT 2}}{{L}_{CT 1}}$$

upon cooling from the first temperature (T₁) to the second temperature (T₂), wherein the first temperature (T₁) is greater than or equal to 1050° C. and the second temperature (T₂) is less than or equal to 800° C. and

$$\vert \frac{{L}_{VT 1} - {L}_{VT 2}}{{L}_{VT 1}} - \frac{{L}_{CT 1} - {L}_{CT 2}}{{L}_{CT 1}} \vert$$

is greater than 0 and less than about 0.0090. In some embodiments,

$$\vert \frac{{L}_{VT 1} - {L}_{VT 2}}{{L}_{VT 1}} - \frac{{L}_{CT 1} - {L}_{CT 2}}{{L}_{CT 1}} \vert$$

is greater than 0 and less than about 0.0070. In some embodiments,

$$\vert \frac{{L}_{VT 1} - {L}_{VT 2}}{{L}_{VT 1}} - \frac{{L}_{CT 1} - {L}_{CT 2}}{{L}_{CT 1}} \vert$$

is greater than 0 and less than about 0.0050. In some embodiments,

$$\vert \frac{{L}_{VT 1} - {L}_{VT 2}}{{L}_{VT 1}} - \frac{{L}_{CT 1} - {L}_{CT 2}}{{L}_{CT 1}} \vert$$

is greater than 0 and less than about 0.0030.

In one or more embodiments, the fining vessel comprising platinum comprises about 60-95% platinum and about 5-40% rhodium by weight. In some embodiments, the fining vessel comprising platinum comprises 60-70% platinum and 30-40% rhodium by weight, 70-80% platinum and 20-30% rhodium by weight, 80-90% platinum and 10-20% rhodium by weight, or 90-95% platinum and 5-10% rhodium by weight.

In some embodiments, the cradle comprises fused cast zirconia or sintered zirconia partially or fully stabilized with one or more of magnesium, calcium, yttrium, strontium, barium, lanthanum, scandium, and cesium. Fused cast zirconia is manufactured by melting batch materials (e.g., in an arc furnace with graphite electrodes), and the melt is poured into a mold (e.g., a graphite mold), followed by a controlled cooling cycle. Refractory materials and shapes produced by such processes can be exposed to reducing atmospheres (e.g., due to graphite electrodes and/or crucibles). Sintered (or bonded) zirconia refractory materials and shapes can be made by any conventional ceramic forming process such as dry pressing, slip casting, etc. The raw materials are prepared to form a batch composition comprising at least about 80% by weight of zirconia, then a green body is formed from the batch composition, and the green body is sintered to form a bonded refractory material. Suitable fused cast and sintered zirconia refractory materials used to provide the cradle can be obtained from commercial suppliers such as Zircoa, Inc. (www.zircoa.com), Monofrax (http://monofrax.com/), or other commercial suppliers of zirconia.

In some embodiments the fused-cast or sinter zirconia comprises a stabilizer selected from one or more of Magnesium, calcium, yttrium, strontium, barium, lanthanum, scandium, and cesium. The amount of stabilizer according to one or more embodiments is in a range of 0.01%-35% by weight on an oxide basis, for example, 0.1%-2%, 0.1%-3%, 0.1%-4%, 0.1%-5%, 0.1%-6%, 0.1%-7%, 0.1%-8%, 0.1%-9%, 0.1%-10%, 0.1%-15%, or 0.1%-20%, 0.1%-25%, or 0.1-30% by weight. In some embodiments, the stabilizer is only magnesium in the aforementioned amounts on an oxide basis, only calcium in the aforementioned amounts or only yttrium in the aforementioned amounts on an oxide basis. In a specific embodiment, the cradle comprises fused cast zirconia or sintered zirconia partially or fully stabilized with yttrium and the fining vessel comprises 80% platinum and 20% rhodium by weight.

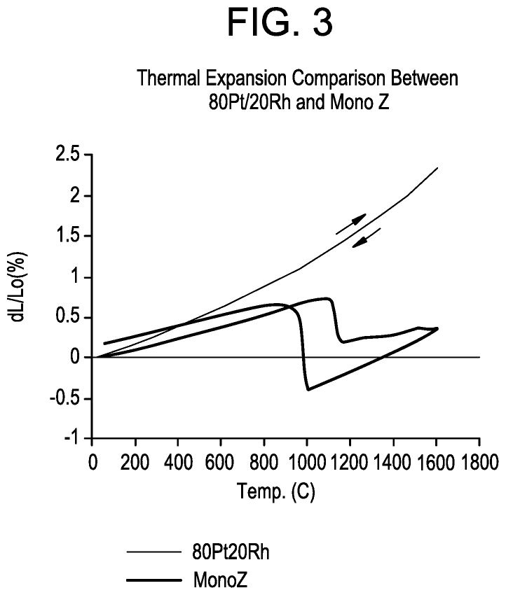

FIG. 3 is a graph showing the thermal expansion behavior of a refractory metal comprising 80% platinum and 20% rhodium by weight compared with a commercially available zirconia refractory Mono-Z, available from Monofrax LLC (monofrax.com). FIG. 3 illustrates the large expansion exhibited upon cooling of the refractory. When such a material is used to form a cradle of a fining apparatus where the cradle partially surrounds the fining vessel, the differential thermal expansion could lead to tearing and rupture of the fining vessel during cooling.

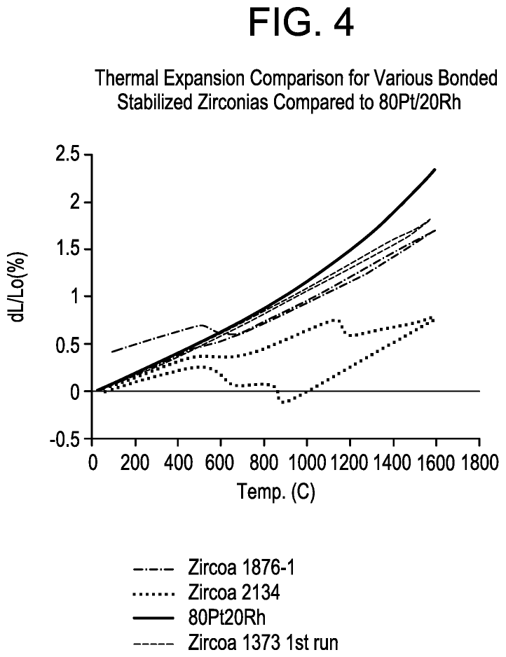

FIG. 4 shows the thermal expansion behavior of a refractory metal comprising 80% platinum and 20% rhodium by weight compared with various bonded refractories in accordance with embodiments of the disclosure. Zircoa 1876 (100% stabilized) and Zircoa 2134 each comprises 95-99% zirconia and 0-10% by weight CaO and/or MgO stabilizer. Zircoa 1373 (100% stabilized) comprises 95-99% Zirconia and 1-30% by weight Y₂O₃ stabilizer. The refractories in FIG. 4 may also contain 1-2% by weight hafnium oxide and 0-1.5% by weight amorphous silica. As can be seen in FIG. 4, the Zircoa 1373 refractory exhibits a thermal expansion that more closely matches the Pt/Rh refractory metal, and the Zircoa 1876 also closely matches the thermal expansion of the Pt/Rh metal. While the Zircoa 2134 (68% stabilized) did not closely match the thermal expansion of the Pt/Rh, it is believed that some degree of partial stabilization may reduce the expansion mismatch enough to protect the Pt/Rh finer tube from failure due to cracking or rupture on cool down in the composition can be made so that the expansion more closely matches the Pt/Rh.

Another aspect of the disclosure pertains to a method of manufacturing a fining apparatus comprising assembling a fining vessel comprising platinum having a length L_{V} and a fused cast or sintered zirconia cradle having a length L_{C} so that the cradle at least partially encloses the fining vessel along the length of the fining vessel, wherein the fining vessel comprising platinum has a first coefficient of thermal expansion such that the fining vessel exhibits a fractional change in length

$$\frac{{L}_{VT 1} - {L}_{VT 2}}{{L}_{VT 1}}$$

upon cooling from a first temperature (T₁) to a second temperature (T₂). The cradle encloses at least a portion of the fining vessel along the length of the fining vessel, and the cradle comprising a material having a second coefficient of thermal expansion such that the cradle exhibits a fractional change in length

$$\frac{{L}_{CT 1} - {L}_{CT 2}}{{L}_{CT 1}}$$

upon cooling from the first temperature (T₁) to the second temperature (T₂), wherein the first temperature (T₁) is greater than or equal to 1050° C. and the second temperature (T₂) is less than or equal to 800° C. and

$$\vert \frac{{L}_{VT 1} - {L}_{VT 2}}{{L}_{VT 1}} - \frac{{L}_{CT 1} - {L}_{CT 2}}{{L}_{CT 1}} \vert$$

is greater than 0 and less than about 0.0090. In some method embodiments, the cradle comprises a material comprising 80-99.99% by weight zirconia that is fused cast or sintered.

In some method embodiments,

$$\vert \frac{{L}_{VT 1} - {L}_{VT 2}}{{L}_{VT 1}} - \frac{{L}_{CT 1} - {L}_{CT 2}}{{L}_{CT 1}} \vert$$

is greater than 0 and less than about 0.0070. In some method embodiments,

$$\vert \frac{{L}_{VT 1} - {L}_{VT 2}}{{L}_{VT 1}} - \frac{{L}_{CT 1} - {L}_{CT 2}}{{L}_{CT 1}} \vert$$

is greater than 0 and less than about 0.0050. In some method embodiments,

$$\vert \frac{{L}_{VT 1} - {L}_{VT 2}}{{L}_{VT 1}} - \frac{{L}_{CT 1} - {L}_{CT 2}}{{L}_{CT 1}} \vert$$

is greater than 0 and less than about 0.0030. In some method embodiments, the fining vessel comprises 60-95% platinum and 5-40% rhodium by weight. In some method embodiments, the cradle comprises fused cast zirconia or sintered zirconia which is partially or fully stabilized with one or more of magnesium, calcium, yttrium, strontium, barium, lanthanum, scandium, and cesium. In some method embodiments, the cradle comprises fused cast zirconia or sintered zirconia stabilized with yttrium and the fining vessel comprises 80% platinum and 20% rhodium by weight.

Another aspect of the disclosure pertains to a method of manufacturing a glass article. An exemplary process for manufacturing glass articles begins with the melting of raw feed materials, such as metal oxides, to form a molten glass. The melting process not only results in the formation of glass, but also the formation of various unwanted by-products, including various gases such as oxygen, carbon dioxide, carbon monoxide, sulfur dioxide, sulfur trioxide, argon, nitrogen, and water. Unless removed, these gases can continue throughout the manufacturing process, ending up as small, sometimes microscopic gaseous inclusions or blisters in the finished glass article.

For some glass articles, the presence of small gaseous inclusions is not detrimental. However, for other articles of manufacture, gaseous inclusions as small as 50 μm in diameter are unacceptable. One such article is the glass sheet used in the manufacture of display devices such as liquid crystal and organic light emitting diode displays. For such applications, the glass desirably has extraordinary clarity, pristine surfaces, free of distortion and inclusions.

To remove gaseous inclusions from the molten glass, a fining agent or agents are typically added to the feed material. The fining agent can be a multivalent oxide of arsenic, antimony or tin. The released oxygen forms gas bubbles in the molten glass. The gas bubbles allow other dissolved gases to be collected and rise to the surface of the melt, where it is removed from the process. The heating is typically performed in a high temperature fining vessel.

Typical fining temperatures for display-grade glasses can be as high as 1740° C. At temperatures this high, specialized metals or alloys are used to prevent destruction of the vessel. Platinum or platinum alloys, such as platinum-rhodium are typically used. Platinum advantageously has a high melting temperature and does not easily dissolve in the glass. Nevertheless, at such high temperatures, the platinum or platinum alloy readily oxidizes. Therefore, steps may be taken to prevent contact between the hot platinum fining vessel and atmospheric oxygen.

In an embodiment, the method comprises fining molten glass in a fining apparatus, the fining apparatus comprising a fining vessel comprising platinum having a length L_{V} and a fused cast or sintered zirconia cradle having a length L_{C}, the fining vessel having a first coefficient of thermal expansion such that the fining vessel exhibits a fractional change in length

$$\frac{{L}_{VT 1} - {L}_{VT 2}}{{L}_{VT 1}}$$

upon cooling from a first temperature (T₁) to a second temperature (T₂); and a cradle enclosing at least a portion of the fining vessel along the length of the fining vessel, the cradle comprising a material having a second coefficient of thermal expansion such that the cradle exhibits a fractional change in length

$$\frac{{L}_{CT 1} - {L}_{CT 2}}{{L}_{CT 1}}$$

upon cooling from the first temperature (T₁) to the second temperature (T₂), wherein the first temperature (T₁) is greater than or equal to 1050° C. and the second temperature (T₂) is less than or equal to 800° C. and

$$\vert \frac{{L}_{VT 1} - {L}_{VT 2}}{{L}_{VT 1}} - \frac{{L}_{CT 1} - {L}_{CT 2}}{{L}_{CT 1}} \vert$$

is greater than 0 and less than about 0.0090. In some embodiments of the method, fining molten glass occurs at temperatures up to temperatures of 1740° C. In some embodiments of the method, the cradle comprises 80-99.99% by weight zirconia that is fused cast or sintered.

In some embodiments of the method,

$$\vert \frac{{L}_{VT 1} - {L}_{VT 2}}{{L}_{VT 1}} - \frac{{L}_{CT 1} - {L}_{CT 2}}{{L}_{CT 1}} \vert$$

is greater than 0 and less than about 0.0070. In some embodiments of the method,

$$\vert \frac{{L}_{VT 1} - {L}_{VT 2}}{{L}_{VT 1}} - \frac{{L}_{CT 1} - {L}_{CT 2}}{{L}_{CT 1}} \vert$$

is greater than 0 and less than about 0.0050. In some embodiments of the method,

$$\vert \frac{{L}_{VT 1} - {L}_{VT 2}}{{L}_{VT 1}} - \frac{{L}_{CT 1} - {L}_{CT 2}}{{L}_{CT 1}} \vert$$

is greater than 0 and less than about 0.0030. In some embodiments of the method, the fining vessel comprises 60-95% platinum and 5-40% rhodium by weight. In some embodiments of the method, the cradle comprises fused cast zirconia or sintered zirconia which is partially or fully stabilized with one or more of magnesium, calcium, yttrium, strontium, barium, lanthanum, scandium, and cesium. In some embodiments of the method, the cradle comprises fused cast zirconia or sintered zirconia which is partially or fully stabilized with yttrium and the fining vessel comprises 80% platinum and 20% rhodium by weight. In some embodiments of the method, upon cooling the fining apparatus from an operating temperature in a range of 1600-1740° C. to a temperature of 25° C., the fining vessel remains intact and does not tear or rupture.

While the foregoing is directed to various embodiments, other and further embodiments of the disclosure may be devised without departing from the basic scope thereof, and the scope thereof is determined by the embodiments that follow.

What is claimed is:

1. A fining apparatus for producing a glass article, the fining apparatus comprising:
a fining vessel comprising platinum having a length L_{V} and cradle having a length L_{C}, the fining vessel having a first coefficient of thermal expansion such that the fining vessel exhibits a fractional change in length
$$\frac{{L}_{VT 1} - {L}_{VT 2}}{{L}_{VT 1}}$$
upon cooling from a first temperature (T₁) to a second temperature (T₂); and
the cradle enclosing at least a portion of the fining vessel along the length of the fining vessel, the cradle comprising a material comprising 80-99.99% by weight zirconia and having a second coefficient of thermal expansion such that the cradle exhibits a fractional change in length
$$\frac{{L}_{CT 1} - {L}_{CT 2}}{{L}_{CT 1}}$$
upon cooling from the first temperature (T₁) to the second temperature (T₂), wherein the first temperature (T₁) is greater than or equal to 1050° C. and the second temperature (T₂) is less than or equal to 800° C. and
$$\vert \frac{{L}_{VT 1} - {L}_{VT 2}}{{L}_{VT 1}} - \frac{{L}_{CT 1} - {L}_{CT 2}}{{L}_{CT 1}} \vert$$
is greater than 0 and less than about 0.0090.

2. The fining apparatus of claim 1, wherein the zirconia is fused cast or sintered.

3. The fining apparatus of claim 2, wherein
$$\vert \frac{{L}_{VT 1} - {L}_{VT 2}}{{L}_{VT 1}} - \frac{{L}_{CT 1} - {L}_{CT 2}}{{L}_{CT 1}} \vert$$
is greater than 0 and less than about 0.0070.

4. The fining apparatus of claim 2, wherein
$$\vert \frac{{L}_{VT 1} - {L}_{VT 2}}{{L}_{VT 1}} - \frac{{L}_{CT 1} - {L}_{CT 2}}{{L}_{CT 1}} \vert$$
is greater than 0 and less than about 0.0050.

5. The fining apparatus of claim 2, wherein
$$\vert \frac{{L}_{VT 1} - {L}_{VT 2}}{{L}_{VT 1}} - \frac{{L}_{CT 1} - {L}_{CT 2}}{{L}_{CT 1}} \vert$$
is greater than 0 and less than about 0.0030.

6. The fining apparatus of claim 2, wherein the fining vessel comprises 60-95% platinum and 5-40% rhodium by weight.

7. The fining apparatus of claim 6, wherein the cradle comprises zirconia partially or fully stabilized with one or more of magnesium, calcium, yttrium, strontium, barium, lanthanum, scandium, and cesium.

8. The fining apparatus of claim 6, wherein the cradle comprises zirconia partially or fully stabilized with yttrium and the fining vessel comprises 80% platinum and 20% rhodium by weight.

9. A method of manufacturing a fining apparatus comprising:
assembling a fining vessel comprising platinum having a length L_{V} and cradle having a length L_{C} so that the cradle at least partially encloses the fining vessel along the length of the fining vessel,
wherein the fining vessel comprising platinum has a first coefficient of thermal expansion such that the fining vessel exhibits a fractional change in length
$$\frac{{L}_{VT 1} - {L}_{VT 2}}{{L}_{VT 1}}$$
upon cooling from a first temperature (T₁) to a second temperature (T₂); and
the cradle enclosing at least a portion of the fining vessel along the length of the fining vessel, and the cradle comprising a material comprising 80-99.99% by weight zirconia and having a second coefficient of thermal expansion such that the cradle exhibits a fractional change in length
$$\frac{{L}_{CT 1} - {L}_{CT 2}}{{L}_{CT 1}}$$
upon cooling from the first temperature (T₁) to the second temperature (T₂), wherein the first temperature (T₁) is greater than or equal to 1050° C. and the second temperature is less than or equal to 800° C. and
$$\vert \frac{{L}_{VT 1} - {L}_{VT 2}}{{L}_{VT 1}} - \frac{{L}_{CT 1} - {L}_{CT 2}}{{L}_{CT 1}} \vert$$
is greater than 0 and less than about 0.0090.

10. The method of claim 9, wherein the zirconia is fused cast or sintered.

11. The method of claim 10, wherein
$$\vert \frac{{L}_{VT 1} - {L}_{VT 2}}{{L}_{VT 1}} - \frac{{L}_{CT 1} - {L}_{CT 2}}{{L}_{CT 1}} \vert$$
is greater than 0 and less than about 0.0070.

12. The method of claim 10, wherein
$$\vert \frac{{L}_{VT 1} - {L}_{VT 2}}{{L}_{VT 1}} - \frac{{L}_{CT 1} - {L}_{CT 2}}{{L}_{CT 1}} \vert$$
is greater than 0 and less than about 0.0050.

13. The method of claim 10, wherein
$$\vert \frac{{L}_{VT 1} - {L}_{VT 2}}{{L}_{VT 1}} - \frac{{L}_{CT 1} - {L}_{CT 2}}{{L}_{CT 1}} \vert$$
is greater than 0 and less than about 0.0030.

14. The method of claim 10, wherein the fining vessel comprises 60-95% platinum and 5-40% rhodium by weight.

15. The method of claim 14, wherein the cradle comprises zirconia partially or fully stabilized with one or more of magnesium, calcium, yttrium, strontium, barium, lanthanum, scandium, and cesium.

16. The method of claim 14, wherein the cradle comprises zirconia partially or fully stabilized with yttrium and the fining vessel comprises 80% platinum and 20% rhodium by weight.

17. A method of manufacturing a glass article comprising:
fining molten glass in a fining apparatus, the fining apparatus comprising:
a fining vessel comprising platinum having a length L_{V} and a cradle having a length L_{C}, the fining vessel having a first coefficient of thermal expansion such that the fining vessel exhibits a fractional change in length
$$\frac{{L}_{VT 1} - {L}_{VT 2}}{{L}_{VT 1}}$$
upon cooling from a first temperature (T₁) to a second temperature (T₂); and
the cradle enclosing at least a portion of the fining vessel along the length of the fining vessel, the cradle comprising a material comprising 80-99.99% by weight zirconia and having a second coefficient of thermal expansion such that the cradle exhibits a fractional change in length
$$\frac{{L}_{CT 1} - {L}_{CT 2}}{{L}_{CT 1}}$$
upon cooling from the first temperature (T₁) to the second temperature (T₂), wherein the first temperature (T₁) is greater than or equal to 1050° C. and the second temperature (T₂) is less than or equal to 800° C. and
$$\vert \frac{{L}_{VT 1} - {L}_{VT 2}}{{L}_{VT 1}} - \frac{{L}_{CT 1} - {L}_{CT 2}}{{L}_{CT 1}} \vert$$
is greater than 0 and less than about 0.0090,
wherein fining molten glass occurs at temperatures up to temperatures of 1740° C.

18. The method of claim 17, wherein the zirconia is fused cast or sintered.

19. The method of claim 18, wherein
$$\vert \frac{{L}_{VT 1} - {L}_{VT 2}}{{L}_{VT 1}} - \frac{{L}_{CT 1} - {L}_{CT 2}}{{L}_{CT 1}} \vert$$
is greater than 0 and less than about 0.0070.

20. The method of claim 18, wherein
$$\vert \frac{{L}_{VT 1} - {L}_{VT 2}}{{L}_{VT 1}} - \frac{{L}_{CT 1} - {L}_{CT 2}}{{L}_{CT 1}} \vert$$
is greater than 0 and less than about 0.0050.

21. The method of claim 18, wherein
$$\vert \frac{{L}_{VT 1} - {L}_{VT 2}}{{L}_{VT 1}} - \frac{{L}_{CT 1} - {L}_{CT 2}}{{L}_{CT 1}} \vert$$
is greater than 0 and less than about 0.0030.

22. The method of claim 18, wherein the fining vessel comprises 60-95% platinum and 5-40% rhodium by weight.

23. The method of claim 22, wherein the cradle comprises zirconia partially or fully stabilized with one or more of magnesium, calcium and yttrium.

24. The method of claim 22, wherein the cradle comprises zirconia partially or fully stabilized with yttrium and the fining vessel comprises 80% platinum and 20% rhodium by weight.

25. The method of claim 22, wherein upon cooling the fining apparatus from an operating temperature in a range of 1600-1740° C. to a temperature of 25° C., the fining vessel remains intact and does not tear or rupture.
